(19) United States
(12) Patent Application Publication
(10) Pub. No.: US 2005/0249500 A1
(43) Pub. Date: Nov. 10, 2005

(54) Passive optical network with protection mechanism and its method of relocation

(76) Inventors: Yi-Ching Liaw, Changhua County (TW); Jim Z. C. Lai, Taichung City (TW); Yun-Lung Chou, Hsinchu (TW); Jia-Jay Duanmu, Pingtung City (TW); Yao-Yaun Chang, Taipei City (JP)

Correspondence Address: HARNESS, DICKEY & PIERCE, P.L.C., P.O. BOX 8910, RESTON, VA, 20195, US

(21) Appl. No.: 11/014,991

(22) Filed: Dec. 20, 2004

(30) Foreign Application Priority Data
May 10, 2004 (TW) 93130146

(51) Int. Cl. H04J 14/00

(52) U.S. Cl. 398/70

(57) ABSTRACT

A passive optical network with a protection mechanism and its method of relocation are provided. A plurality of optical network units is defined in several optical network unit groups. Each optical network unit connects to two couplers. The two couplers connect respectively to two different optical line terminals, which are controlled by a controller. Thus, when the optical lines run out or are overloaded, the controller relocates the optical network units dynamically.

### BACKGROUND OF THE INVENTION

1. Field of Invention

The invention relates to a passive optical network and, in particular, to a passive optical network with a protection mechanism and its method of dynamical relocation.

2. Related Art

Fiber to the premises is the future trend of network development. In particular, the passive optical network has the advantages of low costs in construction, maintenance, and management. Thus, it is a major possible implementation method. The structure of the Passive Optical Network is shown in FIG. 1. A set of passive optical network 10 is comprised of an optical line terminal (OLT) 11, a coupler 12, and several optical network units (ONU) 13. The OLT 11, which is on the central office end 17, is connected via a fiber 14 to the coupler 12 near the user end 18. The coupler 12 is then connected via fibers 15 to various optical network units 13. The optical distribution network between the central office end 17 and the user end 18 uses exclusively passive optical devices and is therefore called the passive optical network 10. The passive optical network 10 has the following major drawbacks:
Low reliability: In the passive optical network 10, the OLT 11, the fiber 14 between the OLT 11 and the coupler 12, and the coupler 12 are shared by all the ONU 13 on the same passive optical network 10. When these shared devices or routes are out of order, all users on the passive optical network 10 will not be able to use the network. This will result in great loss for the business or home users.
Difficult relocation: In the passive optical network 10, the ONU 13 and the OLT 11 are connected by a passive optical device. The circuit cannot be dynamically modified. As the user's bandwidth requirement changes, the configuration of the passive optical network 10 has to be manually changed. The users cannot use the network during the relocation, again resulting in user's loss.
Low bandwidth usage rate: In the passive optical network 10, the network bandwidth is shared by the users on the same passive optical network 10. The bandwidth cannot be shared among different passive optical networks 10. To ensure the bandwidth usage, the passive optical network 10 has to reduce the number of users in order to accommodate peak time usage. In this case, the bandwidth usage rate is generally low for most of the time.

The prior art, such as ITU-T Recommendation G.983.1, “Broadband Optical Access Systems Based on Passive Optical Network”, 1998, proposes four different levels of protection mechanisms. They mainly use extra spare transmission interfaces and circuits to achieve the goals of protection and preventing the network from breaking. However, they still do not have the ability to dynamically adjust the OLT of the ONU.

To avoid using the double-port OLT and ONU, the U.S. Pat. No. 5,896,474 proposes that the central office end adopts the structure of an OLT and an optical exchanger. The user end consists of many user groups, each of which is connected to the optical exchanger of the two OLT via a 2-to-many coupler. The optical exchanger controls the host-slave relations among the ONU groups and the OLT. When disorders occur, the optical exchanger maintains the availability of the network. However, a primary drawback is in the high cost of the optical exchanger. Moreover, it cannot solve the problem of the breakdown of the ONU transmission ports and cannot achieve the ability of dynamically adjust the OLT of a single ONU.

### SUMMARY OF THE INVENTION

In view of the foregoing, an objective of the invention is to provide a passive optical network with a protection mechanism and its method of relocation. It has the ability of relocation of ONU, thereby increasing the usefulness and lowering the maintenance cost of the passive optical network. Moreover, the bandwidth usage rate can be increased.

To achieve the above object, the disclosed passive optical network with a protection mechanism includes several OLT controlled by a controller and several ONU groups. Each OLT connects to a one-to-many first coupler. Each ONU group contains several ONU and is connected to different first couplers via two second couplers.

Therefore, once the optical network, or even the first couplers, the second couplers, or the OLT is out of order, the invention can immediately switch to another normal route without waiting. It thus has a protection mechanism to guarantee the privilege of the business or home users. On the other hand, through the control of the controller and the arrangement of double routing, the invention avoids manual relocation that forbids network usage. The network bandwidth can be optimized by dynamical relocation too.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of a conventional passive optical network;

FIG. 2A is a schematic view of the structure of the invention;

FIG. 2B is a schematic view of the disclosed ONU group;

FIG. 3 is a schematic view of the first embodiment of the invention;

FIG. 4 is a schematic view of the second embodiment of the invention; and

FIG. 5 is a schematic view of the disclosed relocation method.

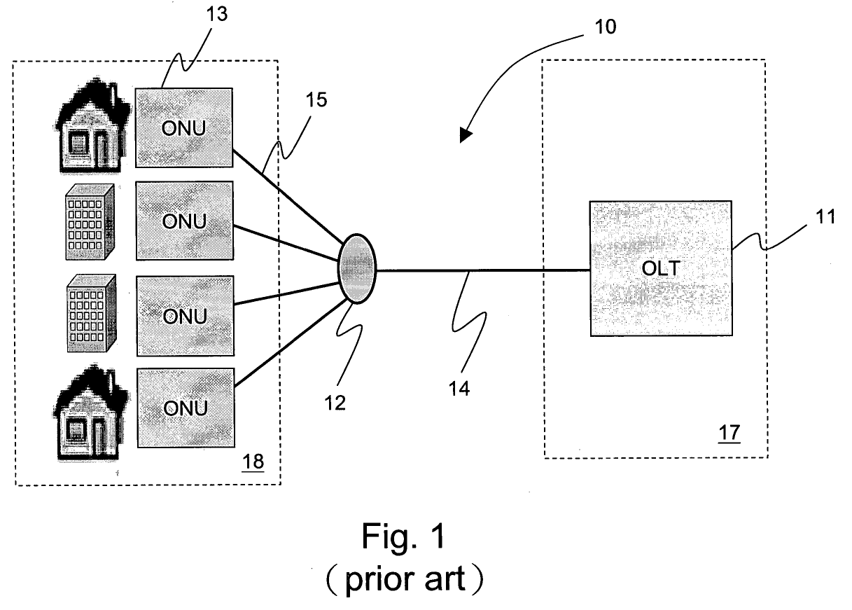

### DETAILED DESCRIPTION OF THE INVENTION

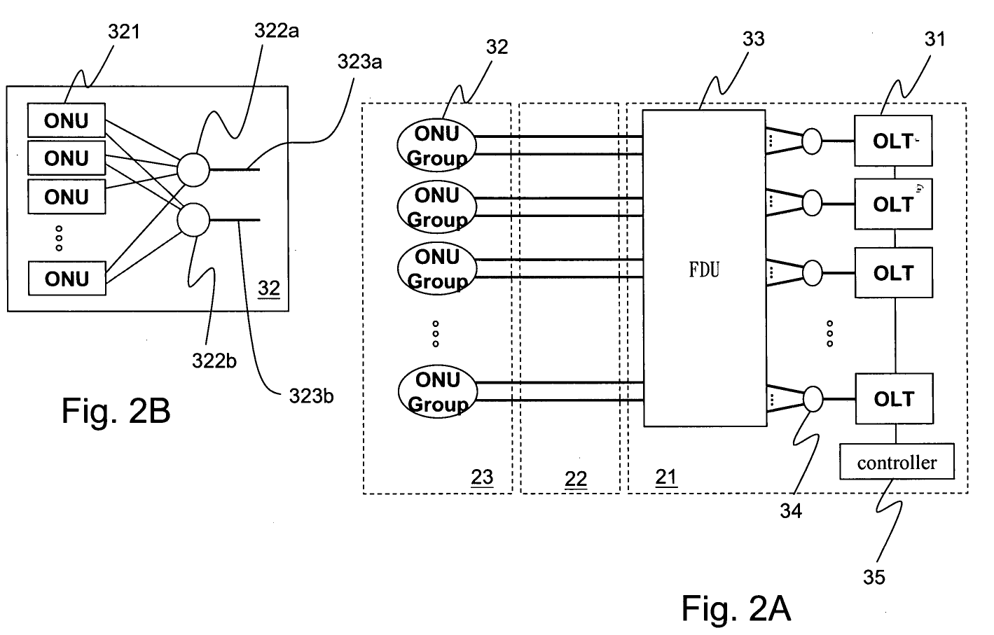

The disclosed passive optical network with a protection mechanism is shown in FIGS. 2A and 2B. It contains several OLT 31s and several ONU groups 32. The OLT 31 is connected to a controller 35 and controlled by the controller 35. It is connected out by a first coupler 34. Each ONU group 32 contains several ONUs 321 and connects out via two fibers 323a, 323b. The two fibers 323a, 323b of each ONU group 32 are connected to the first couplers 34 of different OLTs 31.

The ONU group 32 is located on the user end 23, connecting to the optical network 22 via the two fibers 323a, 323b and then to the central office end 21. In order for each ONU group 32 to connect to the first couplers 34 of different OLTs 31, the central office end 21 is designed with a fiber distribution unit (FDU) 33 to manage the fiber connections. The structure of the ONU group 32 is shown in FIG. 2B. Each ONU 321 is connected to the two second couplers 322a, 322b through two transmission ports, respectively. Only one of the transmission ports functions at a time. Based upon network load, bandwidth usage or cost consideration, one can adopt the design that the ONU 321 only connect to one of the second couplers 322a, 322b.

For this purpose, the second couplers 322a, 322b are many-to-one couplers, and the first coupler 34 is a one-to-many coupler. When the network is out of order (the OLT 31, the fiber between the OLT 31 and the first coupler 34, the first coupler 34, the fiber between the first coupler 34 and the second coupler 322a, 322b, the second coupler 322a, 322b, the fiber between the second coupler 322a, 322b and the ONU 321, or even a transmission port of the ONU), the ONU 321 can immediately switches to the transmission port corresponding to the other second coupler 322a, 322b, connecting to another OLT 31 via a different optical network 22. This maintains the normal function of the network. The FDU 33 is designed to be located on the central office end 21 for the convenience of maintenance.

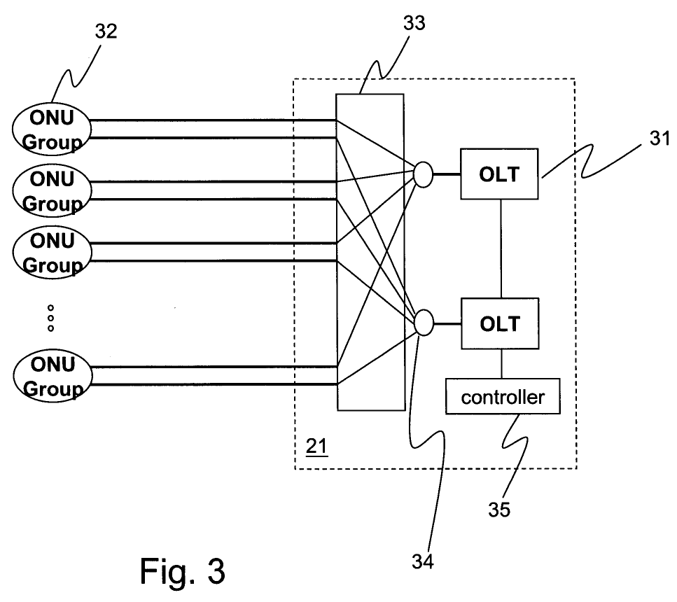

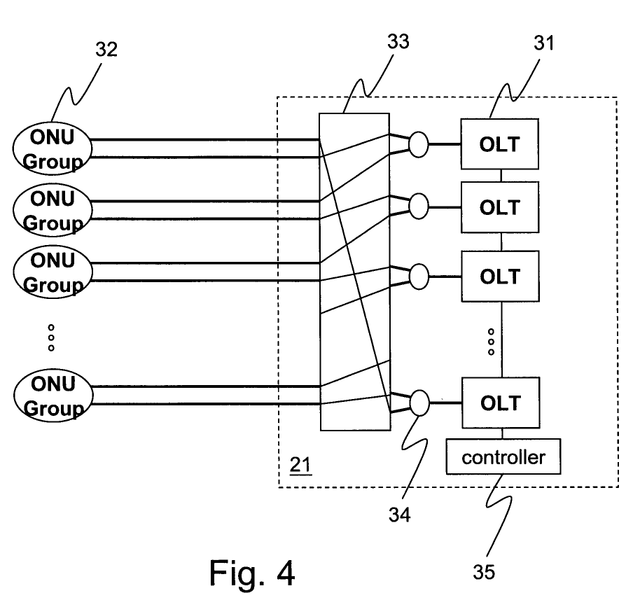

In the following, we use two embodiments to explain the invention. As shown in FIG. 3, the first embodiment has two OLTs 31 for several ONU groups 32. Since each ONU group 32 has two output fibers, one thus needs to use the FDU 33 for them to connect respectively to the two OLTs 31. In order to balance the bandwidth and load, the ONU groups 32 (or the ONU contained therein) can be initially logged into two OLT 31 evenly. If any part of the passive optical network is out of order, the controller 35 switches to an available route for protection. In a second embodiment of the invention, one has several OLT 31 for several ONU groups 32. This makes the distribution more even.

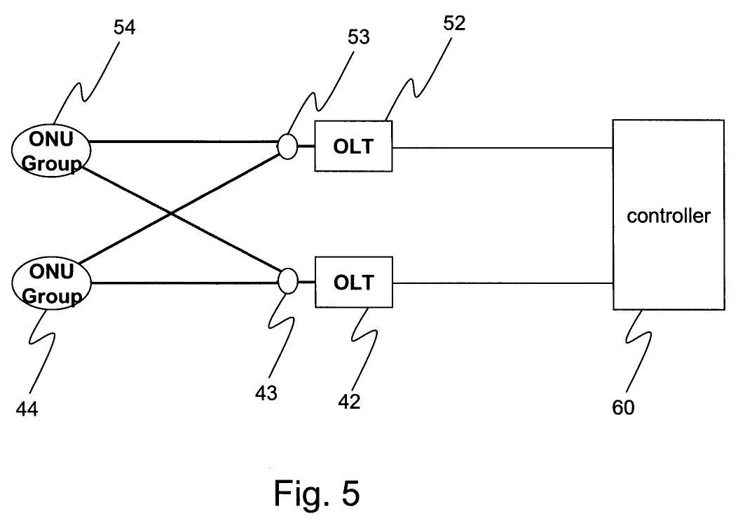

The disclosed dynamical relocation method is shown in FIG. 5. The dynamical relocation is performed whenever the passive optical network is out of order or the bandwidth monitoring is out of balance. The first ONU group 54 and the second ONU group 44 are connected to the original OLT 52 and the relocated OLT 42 via the couplers 53, 43, respectively. Both the original OLT 52 and the relocated OLT 42 are controlled by the controller 60. Suppose one wants to adjust the ONU on the original. OLT 52, the controller 60 first sends the relocation message to the original OLT 52. Once the relocation message is received, the original OLT 52 returns the information of the currently linked ONU to the controller 60. The ONU may come from either the first ONU group 54 or the second ONU group 44. Afterwards, the controller 60 sends the information to the relocated OLT 42 for registration. After the registration, the relocated OLT 42 returns a registration message to the controller 60 and then to the original OLT 52 for further distribution to all the corresponding ONUs (possibly in the first ONU group 54, the second ONU group 44, or both). The controller 60 relocates them and notifies the corresponding ONU for them to switch to the relocated OLT 42. This can increase the availability of the network, reduce the time and manpower costs needed for the dynamical relocation, and the bandwidth usage rate of the passive optical network.

Certain variations would be apparent to those skilled in the art, which variations are considered within the spirit and scope of the claimed invention.

1. A passive optical network with a protection mechanism, comprising:
a plurality of optical line terminals (OLT), each connecting to a common controller and a corresponding first coupler; and
a plurality of optical network unit (ONU) group, each including a plurality of ONU connected to two second couplers; wherein the ONU is selectively coupled to the first coupler corresponding to a different said OLT via the second coupler.

2. The passive optical network with a protection mechanism of claim 1, wherein the first coupler is a one-to-many coupler.

3. The passive optical network with a protection mechanism of claim 1 further comprising a fiber distribution unit (FDU) to connect the first couplers and the second couplers.

4. The passive optical network with a protection mechanism of claim 3, wherein the second coupler is connected to the FDU via an optical network.

5. The passive optical network with a protection mechanism of claim 3, wherein the FDU and the OLT are installed on a central office end.

6. The passive optical network with a protection mechanism of claim 1, wherein the second coupler is a one-to-many coupler.

7. The passive optical network with a protection mechanism of claim 6, wherein some of the ONU in the ONU group are connected to at least one of the second couplers.

8. The passive optical network with a protection mechanism of claim 6, wherein the ONU in the ONU group are connected to the two second couplers.

9. A passive optical network relocation method for a passive optical network which includes a plurality of OLT (optical line terminal), a plurality of ONU (optical network unit) groups, and a controller, each of the ONU groups including a plurality of ONU connected to at least two couplers that are connected to different said OLT, and the OLT being controlled by the controller, wherein the method comprising the steps of:
sending a relocation message to one of the original OLT by the controller;
returning information of currently linked ONU from the OLT to the controller;
registering to a relocated OLT according to the information by the controller;
returning a registration message from the relocated OLT;
sending the registration message via the original OLT to the linked ONU;
relocating the ONU by the controller; and
notifying the ONU to switch to the relocated OLT.

10. The method of claim 9, wherein the ONU linked to the original OLT are from the same ONU group.

11. The method of claim 9, wherein the ONU linked to the original OLT are from different said ONU group.

12. The method of claim 9, wherein the step of the controller registering to a relocated OLT according to the information is done by the controller registering to a plurality of relocated OLT simultaneously.
